(19) United States
(12) Patent Application Publication
(10) Pub. No.: US 2019/0144718 A1
(43) Pub. Date: May 16, 2019

(54) STRUCTURAL ADHESIVE FILM, METAL MEMBER ASSEMBLY, AND METHOD FOR MANUFACTURING THE SAME

(71) Applicant: 3M INNOVATIVE PROPERTIES COMPANY, St. Paul, MN (US)

(72) Inventor: Takuma AIZAWA, Tokyo (JP)

(21) Appl. No.: 16/098,182

(22) PCT Filed: May 11, 2017
(86) PCT No.: PCT/US2017/032114

§ 371 Date: Nov. 1, 2018

(30) Foreign Application Priority Data
May 12, 2016 (JP) 2016-096076

(51) Int. Cl. C09J 7/35; B32B 7/12; B32B 5/02; B32B 15/14; B32B 15/04; B32B 15/092; B32B 15/082; B32B 15/18; C09J 5/06; C09J 7/10; B21D 39/02

(52) U.S. Cl. CPC C09J 7/35; B62D 27/026; B32B 5/02; B32B 15/14; B32B 15/046; B32B 15/092; B32B 15/082; B32B 15/18; C09J 5/06; C09J 7/10; B21D 39/028; B32B 2307/724; C09J 2463/00; C09J 2433/00; C09J 2400/24; B32B 7/12

(57) ABSTRACT

A structural adhesive film is provided whereby both adhesion and edge coverage can be achieved. The structural adhesive film (1) includes a first curable resin layer (1a) containing a first thermosetting resin and a first foaming agent; and a second curable resin layer (1b) containing a second thermosetting resin. A curing temperature of the first curable resin layer (1a) is lower than a curing temperature of the second curable resin layer (1b); and a foaming starting temperature of the first foaming agent is lower than the curing temperature of the first curable resin layer (1a).

### TECHNICAL FIELD

The present invention relates to a structural adhesive film, a metal member assembly, and a method for manufacturing the same.

### BACKGROUND ART

Methods exist for adhering metal members used in automobiles and the like in which the metal members are adhered to each other via an adhesive. For example, in WO/2012/166257, when using two steel plates (an outer steel plate and an inner steel plate) to form a hem flange structure in which an end portion of the outer steel plate is pressed so as to sandwich the inner steel plate, an adhesive sheet is disposed between the outer steel plate and the inner steel plate so as to adhere the steel plates to each other.

### SUMMARY OF INVENTION

When forming a hem flange structure, the outer steel plate and the inner steel plate must be adhered to each other with sufficient strength. Additionally, the adhesive that is used is preferably an adhesive that can sufficiently cover an end surface and cutting angle (hereinafter referred to as “edge”) of the outer steel plate.

An object of the present invention is to provide a structural adhesive film whereby both adhesion and edge coverage can be achieved, and a metal member assembly in which the structural adhesive film is used and a method for manufacturing the same.

One aspect of the present invention is a structural adhesive film including a first curable resin layer containing a first thermosetting resin and a first foaming agent; and a second curable resin layer containing a second thermosetting resin. In this structural adhesive film, a curing temperature of the first curable resin layer is lower than a curing temperature of the second curable resin layer; and a foaming starting temperature of the first foaming agent is lower than the curing temperature of the first curable resin layer.

According to the present invention, a structural adhesive film whereby both adhesion and edge coverage are achieved, and a metal member assembly in which the structural adhesive film is used and a method for manufacturing the same can be provided.

### BRIEF DESCRIPTION OF THE DRAWINGS

FIG. 1 is a schematic cross-sectional view illustrating a structural adhesive film according to an embodiment of the present invention.

FIG. 2 is a schematic cross-sectional view along line II-II of FIG. 1, in the direction of the arrows.

FIGS. 3A to 3C are schematic cross-sectional views illustrating a method for manufacturing a metal member assembly according to an embodiment of the present invention.

FIGS. 4A to 4C are exploded schematic cross-sectional views of main constituents of a metal adhered body in a heating step in the manufacturing method depicted in FIGS. 3A to 3C.

FIGS. 5A and 5B are schematic cross-sectional views illustrating a metal member assembly according to another embodiment of the present invention.

FIGS. 6A and 6B are schematic cross-sectional views for explaining a method for manufacturing the metal member assembly depicted in FIG. 5B.

FIGS. 7A to 7C are schematic cross-sectional drawings illustrating an evaluation method of T-peel strength in the examples.

FIGS. 8A to 8C are schematic cross-sectional drawings illustrating an evaluation method of shear strength in the examples.

FIGS. 9A to 9C are cross-section photographs illustrating an edge portion of an outer steel plate of the metal member assemblies according to Working Examples 1 and 2 and Comparative Example 1.

FIGS. 10A to 10C are cross-section photographs illustrating an edge portion of an outer steel plate of the metal member assemblies according to Working Examples 3, 4, and 5.

FIG. 11 is a cross-section photograph illustrating an edge portion of an outer steel plate of the metal member assembly according to Comparative Example 2.

### DESCRIPTION OF EMBODIMENTS

Hereinafter, while referencing the drawings, detailed descriptions are given of embodiments of a structural adhesive film, a metal member assembly, and a method for manufacturing the metal member assembly according to the present invention.

A structural adhesive film according to an embodiment of the present invention includes a first curable resin layer containing a first thermosetting resin and a first foaming agent; and a second curable resin layer containing a second thermosetting resin. In this structural adhesive film, a curing temperature of the first curable resin layer is lower than a curing temperature of the second curable resin layer; and a foaming starting temperature of the first foaming agent is lower than the curing temperature of the first curable resin layer. In this specification, the term “film” encompasses products referred to as “sheets”.

With the structural adhesive film, the curing temperature of the first curable resin layer is lower than the curing temperature of the second curable resin layer and the foaming starting temperature of the first foaming agent is lower than the curing temperature of the first curable resin layer. Therefore, the foaming of the first foaming agent starts before the curing of the first curable resin layer and the second curable resin layer. As a result, the first curable resin layer and the second curable resin layer are in a very fluid state at a time of the starting of the foaming of the first foaming agent, and the structural adhesive film (particularly the first curable resin layer) expands due to the foaming of the first foaming agent. Accordingly, in cases where the structural adhesive film is used to adhere an inner steel plate near an edge of an outer steel plate, it is possible to cover the edge while maintaining adhesion.

In this specification, the term “curing temperature” refers to a temperature corresponding to a changing point where the slope of a DSC curve (vertical axis: heat quantity, horizontal axis: temperature) obtained through differential scanning calorimetry (hereinafter referred to as “DSC measurement”) changes to positive. Note that the term “curing temperature” can also be expressed as “curing starting temperature”.

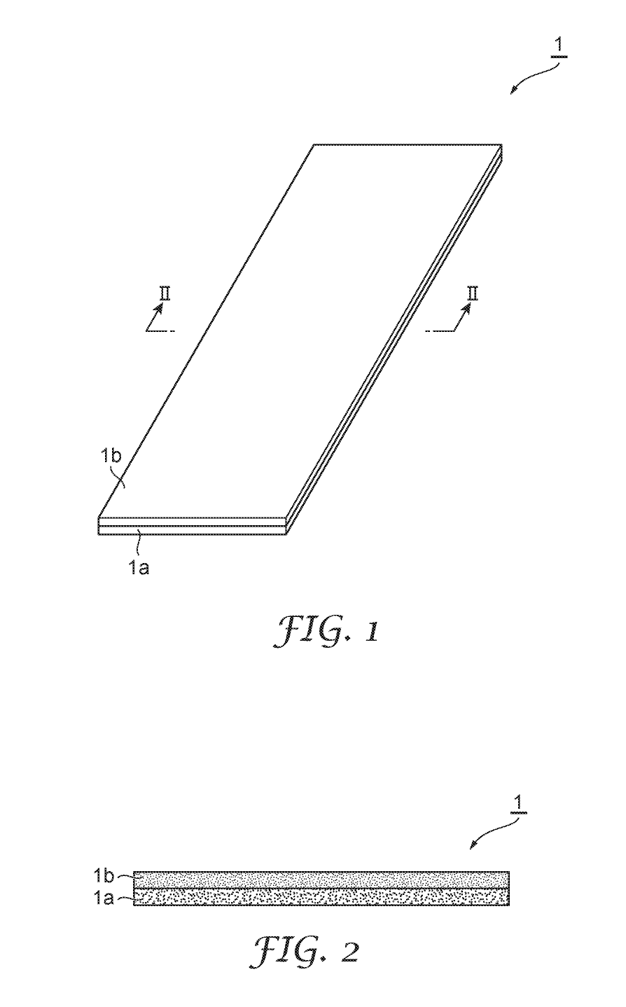

FIG. 1 is a perspective view illustrating a structural adhesive film according to an embodiment of the present invention. FIG. 2 is a schematic cross-sectional view along line II-II of FIG. 1, in the direction of the arrows. The structural adhesive film 1 includes a first curable resin layer 1a and a second curable resin layer 1b.

A first thermosetting resin contained in the first curable resin layer 1a and a second thermosetting resin contained in the second curable resin layer 1b may be the same or may differ from each other. Examples of the thermosetting resin that can be used include epoxy resins, urethane resins, silicone resins, and the like. Among these, epoxy resins are preferable from the perspectives that resin strength is superior and adhesive strength after curing is greater.

In cases where using an epoxy resin as the thermosetting resin, an epoxy equivalent of the epoxy resin may, for example, be from 100 to 250 g/eq. A weight average molecular weight of the epoxy resin may, for example, be from 200 to 700. The number of polymerizable epoxy groups contained in each molecule of the epoxy resin may, for example, be from 2 to 4.

Examples of such an epoxy resin include bisphenol A, bisphenol E, bisphenol F, bisphenol S, aliphatic or aromatic amines, bisphenol resins substituted with halogens, novolac resins, aliphatic epoxy compounds, and resins derived from mixtures of these resins. The epoxy resin may be liquid or semi-liquid at room temperature.

Examples of commercially available products that can be used as the epoxy resin include “EPOTOHTO® YD-128” (both manufactured by Nippon Steel & Sumikin Chemical Co., Ltd. (Tokyo, Japan)), “JER828” (manufactured by Mitsubishi Chemical Corporation (Tokyo, Japan)), and “ADEKA RESIN EP4000” and “ADEKA RESIN EP4100” (both manufactured by ADEKA Corporation (Tokyo, Japan)).

An amount of the thermosetting resin in each of the first curable resin layer 1a and the second curable resin layer 1b independently is preferably from 30 to 70 mass %, based on an entire mass of each of the curable resin layers. When the amount of the thermosetting resin is greater than or equal to 30 mass %, adhesive strength will be more superior, and when the amount is less than or equal to 70 mass %, the film shape of the structural adhesive film can be advantageously retained. The amount of the thermosetting resin may, for example, be from 40 to 70 mass % or from 60 to 70 mass %, based on the entire mass of each of the curable resin layers.

Examples of foaming agents that can be used as the first foaming agent contained in the first curable resin layer 1a include encapsulated type foaming agents in which a shell containing the thermoplastic resin is filled with a liquid hydrocarbon such as butane, or pentane. In cases where using an encapsulated type foaming agent, the shell expands upon heating of the foaming agent due to the liquid matter in the shell vaporizing. An amount of the encapsulated type foaming agent is preferably from 0.5 to 10 mass %, more preferably from 1 to 5 mass %, and even more preferably from 1 to 2 mass %, based on the entire mass of the first curable resin layer 1a. Examples of such encapsulated type foaming agents that are commercially available include “Matsumoto Microsphere®” (manufactured by Matsumoto Yushi-Seiyaku Co., Ltd. (Osaka, Japan)), “Expancel®” (manufactured by Japan Fillite Co., Ltd. (Osaka, Japan)), and “Advancell®” (manufactured by Sekisui Chemical Co., Ltd. (Osaka, Japan)).

Additionally, a compound, namely a non-encapsulated type foaming agent that produces, for example, a gas such as nitrogen, nitrogen oxide, steam, or carbon dioxide upon heating can be used as the first foaming agent. Examples of non-encapsulated type foaming agents that can be used include azobisisobutyronitrile, azodicarbonamide, carbazides, hydrazides, sodium borohydride, sodium bicarbonate, sodium citrate, and dinitrosopentamethylene tetramine. An amount of the non-encapsulated type foaming agent is preferably from 0.2 to 2 mass % and more preferably from 0.5 to 1.5 mass %, based on the entire mass of the first curable resin layer 1a.

An expansion rate, due to the first foaming agent, of the first curable resin layer is preferably 110% or greater, 120% or greater, or 130% or greater, and is preferably 160% or less, 150% or less, or 140% or less. When the expansion rate is 110% or greater, coverage of the edge is more superior, and when the expansion rate is 160% or less, adhesive strength is more advantageously maintained. In this specification, the term “expansion rate” means a layer thickness of the first curable resin layer after foaming/curing with regards to the layer thickness before foaming.

The second curable resin layer 2a may further contain a second foaming agent. The second foaming agent may be the same or different from the first foaming agent, or may be one of the foaming agents described as the first foaming agent. A foaming starting temperature of the second foaming agent is, for example, preferably from 90 to 150° C. and is preferably lower than the curing temperature of the second curable resin layer 1b. In other words, the second foaming agent begins foaming before the completion of the curing of the second curable resin layer 1b. The foaming starting temperature of the second foaming agent is more preferably higher than the curing temperature of the first curable resin layer 1a.

A foaming starting temperature of the first foaming agent may, for example, be from 80 to 130° C. or from 100° C. to 120° C. When the foaming starting temperature is 80° C. or higher, unnecessary foaming when molding the structural adhesive film 1 can be prevented. The foaming starting temperature of the first foaming agent is preferably lower than the curing temperature of the first curable resin layer 1a. In other words, the first foaming agent preferably begins foaming before the completion of the curing of the first curable resin layer 1a.

The foaming starting temperature of the second foaming agent is preferably higher than the foaming starting temperature of the first foaming agent. A difference between the foaming starting temperature of the first foaming agent and the foaming starting temperature of the second foaming agent is preferably 5° C. or greater and more preferably 10° C. or greater. The difference between the foaming starting temperature of the first foaming agent and the foaming starting temperature of the second foaming agent may, for example, be 70° C. or less.

In this specification, the term “foaming starting temperature” refers to a temperature at which volumetric expansion exceeds so-called normal thermal expansion in a thermomechanical analysis measuring volumetric change along with temperature change. Note that, typically, “foaming starting temperatures” of forming agents are listed in product specifications provided by foaming agent manufacturers.

Each of the first curable resin layer 1a and the second curable resin layer 1b may further contain an acrylic resin in addition to the components described above, and preferably contain the epoxy resin described above and an acrylic resin. By containing an acrylic resin, tackiness and moldability before curing can be increased.

The acrylic resin is not particularly limited and may, for example, be a copolymer of a (meth)acrylic acid ester, a nitrogen-containing monomer, and a crosslinking monomer having an epoxy group.

The (meth)acrylic acid ester preferably is a (meth)acrylic acid ester with a homopolymer Tg of 80° C. or higher. The (meth)acrylic acid ester may, for example, be a monomer represented by Formula (1) below.

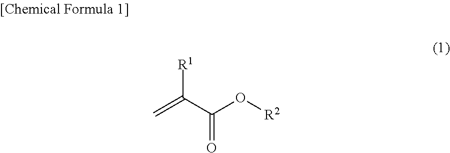

In Formula (1), R¹ is a hydrogen atom or methyl group, and R² is a hydrocarbon group. Provided that R² is a hydrocarbon group where the homopolymer Tg is 80° C. or higher, R² may be a chain, branched, or cyclic hydrocarbon group.

An amount of the (meth)acrylic acid ester may, for example, be 20 mass % or greater or 30 mass % or greater, and may be 60 mass % or less, based on an entire mass of the monomer components.

The nitrogen-containing monomer is a monomer that contains nitrogen atoms and is capable of copolymerizing with the (meth)acrylic acid ester and the crosslinking monomer to form the acrylic resin. The nitrogen-containing monomer may, for example, be a monomer having an ethylenically unsaturated double bond or may be a monomer having a (meth)acryloyl group.

An amount of the nitrogen-containing monomer may, for example, be 20 mass % or greater, and may be 50 mass % or less, based on the entire mass of the monomer components.

The crosslinking monomer is a monomer that has an epoxy group and is capable of copolymerizing with the (meth)acrylic acid ester and the nitrogen-containing monomer to form the acrylic resin. The crosslinking monomer may, for example, be a monomer having an ethylenically unsaturated double bond or may be a monomer having a (meth)acryloyl group. The crosslinking monomer may, for example, be a monomer having a glycidyl group.

An amount of the crosslinking monomer may, for example, be 2 mass % or greater, 5 mass % or greater, or 10 mass % or greater, and may, for example, be 30 mass % or less, 25 mass % or less, or 20 mass % or less, based on the entire mass of the monomer components.

The acrylic resin contained in the first curable resin layer and the second curable resin layer may be a radical polymerizable acrylic resin. In this case, it is possible to mold a sheet shape structural adhesive film by photopolymerization.

The form of polymerization of the monomer components is not particularly limited and may, for example, be random polymerization. That is, the acrylic resin may be a random copolymer of monomer components such as those described above.

The polymerization reaction of the monomer components is not particularly limited, but is preferably radical polymerization. That is, the acrylic resin is preferably a radical copolymer of monomer components such as those described above. The radical polymerization may, for example, be carried out by reacting the monomer components with a radical polymerization initiator.

The radical polymerization initiator is not particularly limited, provided that the radical polymerization of the monomer components can be initiated. For example, the radical polymerization initiator may be a photocurable radical polymerization initiator. Specific examples of the radical polymerization initiator include 2,2-dimethoxy-1,2-diphenylethane-1-one (Irgacure 651, manufactured by BASF), bis(2,4,6-trimethylbenzoyl) phenyl phosphine oxide (Irgacure 819, manufactured by BASF), and the like. An amount of the radical polymerization initiator is not particularly limited and, for example, may be from 0.05 to 0.5 parts by mass or from 0.1 to 0.3 parts by mass per a total of 100 parts by mass of the monomer components.

Each of the first curable resin layer 1a and the second curable resin layer 1b may further contain other components in addition to the components described above. Examples of the other components include thermoplastic resins, modifiers, curing agents, curing aids, spacers, and the like.

Examples of thermoplastic resins that can be used include phenoxy resins, polyether resins, polypropylene resins, polyvinyl chloride resins, polyester resins, polycaprolactone resins, polystyrene resins, polycarbonate resins, polyamide resins, butyral resins, and combinations thereof. Examples of such thermoplastic resins that are commercially available include “YP-50S” (manufactured by Nippon Steel & Sumikin Chemical Co., Ltd. (Tokyo, Japan)), “PK-HP200” (manufactured by InChem), “Butvar B76” (manufactured by Eastman Chemical), “Hi-Pearl M-5001” (manufactured by Negami Chemical Industrial Co., Ltd. (Ishikawa Prefecture, Japan)), and the like. In cases where the first curable resin layer 1a and the second curable resin layer 1b contain the epoxy resin and the acrylic resin, a phenoxy resin and a butyral resin, which exhibit excellent miscibility to these resins, are preferably used as the thermoplastic resin. A softening point of the thermoplastic resin may, for example, be from 60 to 140° C. The thermoplastic resin is mainly responsible for shape retention before curing at room temperature.

An amount of the thermoplastic resin in each of the first curable resin layer 1a and the second curable resin layer 1b independently is preferably from 10 to 50 mass % and more preferably from 15 to 30 mass %, based on the entire mass of each of the curable resin layers.

Examples of modifiers that can be used include core-shell type modifiers, carboxyl group-terminated acrylonitrile-butadiene rubber, and high molecular weight amine-terminated polytetramethylene oxide. Examples of such modifiers that are commercially available include “BTA-731” (manufactured by Kureha Corporation).

An amount of the modifier in each of the first curable resin layer 1a and the second curable resin layer 1b independently is preferably from 10 to 40 mass % and more preferably from 10 to 30 mass %, based on the entire mass of each of the curable resin layers.

The modifier is selected in accordance with the type of thermosetting resin. In cases where the thermosetting resin is an epoxy resin, the curing agent may be an acid anhydride (e.g., 4-methyl-hexahydrophthalic anhydride or the like), an aromatic polyamine (e.g., diaminodiphenylmethane or the like), a phenolic resin system, a dicyandiamide, or the like and, from the perspective of having stable latency at room temperature, is preferably a dicyandiamide. Examples of such curing agents that are commercially available include “Amicure® CG1200” (manufactured by Air Products) and “EH-3636AS” (manufactured by ADEKA Corporation).

An amount of the curing agent in each of the first curable resin layer 1a and the second curable resin layer 1b independently is preferably from 2 to 15 mass % and more preferably from 2 to 8 mass %, based on the entire mass of each of the curable resin layers.

The curing aid is used to control the curing temperatures of the first curable resin layer 1a and the second curable resin layer 1b by being combined with, for example, the dicyandiamide. Preferably, the curing aid is a compound by which the curing temperature of the first curable resin layer 1a can be controlled to be lower than the curing temperature of the second curable resin layer 1b and the foaming starting temperature of the first foaming agent can be controlled to be lower than the curing temperature of the first curable resin layer 1a; and may, for example, be a tertiary amine salt or an imidazole. Examples of such curing aids that are commercially available include “Omicure® 52” (manufactured by BTR Japan), “Curezol 2MZA”, “Curezol 2MA-OK”, and “Curezol 2PHZ” (all manufactured by Shikoku Chemicals Corporation), and the like.

Examples of spacers that can be used as the spacer include glass beads. Examples of such spacers that are commercially available include “910L” (manufactured by Unitika Ltd.).

An amount of the spacer in each of the first curable resin layer 1a and the second curable resin layer 1b independently is, for example, 0.5 mass % or less, based on the entire mass of each of the curable resin layers.

In the present embodiment, the curing temperature of the first curable resin layer 1a is lower than the curing temperature of the second curable resin layer 1b. In other words, the second curable resin layer 1b has fluidity when the first curable resin layer 1a has cured to the point where the shape thereof can be retained.

Specifically, the curing temperature of the first curable resin layer 1a is preferably from 90 to 150° C., more preferably from 110 to 140° C., and even more preferably from 120 to 140° C. The curing temperature of the second curable resin layer 1b is preferably from 100 to 170° C., more preferably from 120 to 160° C., and even more preferably from 130 to 150° C. A difference between the curing temperature of the first curable resin layer 1a and the curing temperature of the second curable resin layer 1b is preferably 5° C. or greater and more preferably 10° C. or greater. The difference between the curing temperature of the first curable resin layer 1a and the curing temperature of the second curable resin layer 1b may, for example, be 80° C. or less.

A composition of the first curable resin layer 1a and the second curable resin layer 1b described above is appropriately adjusted so that the curing temperature of the first curable resin layer 1a is lower than the curing temperature of the second curable resin layer 1b, and the difference between the curing temperature of the first curable resin layer 1a and the curing temperature of the second curable resin layer 1b is preferably within the range described above.

Specifically, for example, by using different types of thermosetting resins for the first curable resin layer 1a and the second curable resin layer 1b, the curing temperature of the first curable resin layer 1a can be set lower than the curing temperature of the second curable resin layer 1b.

Additionally, for example, by appropriately selecting the curing aid as described above, and by configuring the amount of the curing aid in the first curable resin layer 1a to be greater than the amount of the curing aid in the second curable resin layer 1b, the curing temperature of the first curable resin layer 1a can be set lower than the curing temperature of the second curable resin layer 1b.

More specifically, by using different curing aids for the first curable resin layer 1a and the second curable resin layer 1b, the curing starting temperature of the first curable resin layer 1a can be set lower than the curing starting temperature of the second curable resin layer 1b. In an example where imidazole curing aids are used, a preferable curing temperature difference between the first curable resin layer 1a and the second curable resin layer 1b can be provided by using “Curezol 2MZ-A” as the curing aid of the first curable resin layer 1a and “Curezol 2PHZ-PW” as the curing aid of the second curable resin layer 1b.

Additionally, the amount of the curing aid in the first curable resin layer 1a is preferably from 0.1 to 3.0 mass % and more preferably from 0.2 to 1.5 mass %, based on the entire mass of the first curable resin layer 1a. The amount of the curing aid in the second curable resin layer 1b is preferably about half of the amount of the curing aid in the first curable resin layer 1a (e.g. from 45 to 55 parts by mass per 100 parts by mass of the amount of the curing aid in the first curable resin layer 1a). As a result, a preferable curing temperature difference between the first curable resin layer 1a and the second curable resin layer 1b can be provided.

The structural adhesive film according to the present embodiment may further include other layers in addition to the first curable resin layer and the second curable resin layer. For example, an air-permeable material such as a woven fabric, a nonwoven fabric, or a mesh may be disposed within one or both of, or may be interposed between, the first curable resin layer 1a and the second curable resin layer 1b. As a result, the properties of the structural adhesive film 1 before curing can be improved. Additionally, for example, a very thin thermoplastic resin film may be provided on the second curable resin layer. As a result, further improvement in the surface appearance after curing can be expected.

The structural adhesive film according to the present embodiment can, for example, be obtained as follows, as an embodiment.

1) First the thermosetting resin and the modifier are mixed and heated to a point of becoming sufficiently wet (e.g. two hours or longer at 120° C.). Then, the mixture is heated to the point where the thermoplastic resin melts (e.g. about 180° C.), and the mixture of the thermosetting resin and the modifier is mixed further.

2) The mixture resulting from 1) is cooled to a temperature at which the reaction will not quickly proceed when later adding the curing agent, aid, and foaming agent, and at which the fluidity of the mixture is not adversely affected (while dependent on the types and amounts of the curing agent, aid, and foaming agent, about 70° C., for example). Then, the curing agent, the curing aid, and the foaming agent are further mixed into the mixture.

3) Before the mixture resulting from 2) cools/solidifies, the mixture is molded into a sheet shape via calendaring or hot pressing.

4) The first curable resin layer 1a and the second curable resin layer 1b fabricated independently by following 1) to 3) are adhered to each other. Thus, the structural adhesive film 1 is obtained.

In the structural adhesive film according to the present embodiment, in cases where a radical curable acrylic resin is used along with the thermosetting resin, another embodiment, such as the following process, can be used to obtain the structural adhesive film.

1) The acrylic monomer having acrylic resin as a raw material is compounded and the thermoplastic resin, the epoxy resin, and other thermosetting resin are dissolved.

2) The light-reactive initiator for the acrylic resin, the curing agent, the curing aid, the foaming agent, the filler, and other additives are added, agitated, and dispersed into the mixture obtained in 1).

3) The mixture is degassed so as to remove the oxygen, and is sandwiched between a pair of transparent films made from PET or the like, so as to become a desired thickness.

4) 3) is light-irradiated so as to cause the acryl monomers to react and polymerize, and the mixture is molded into a sheet shape.

5) The first curable resin layer 1a and the second curable resin layer 1b fabricated independently by following 1) to 4) are adhered to each other. Thus, the structural adhesive film 1 is obtained.

The structural adhesive film according to the present embodiment can be used for adhering metal members together to manufacture a metal member assembly. Hereinafter, an embodiment of a method for manufacturing a metal member assembly using the structural adhesive film (a method for bonding metal members together) is described.

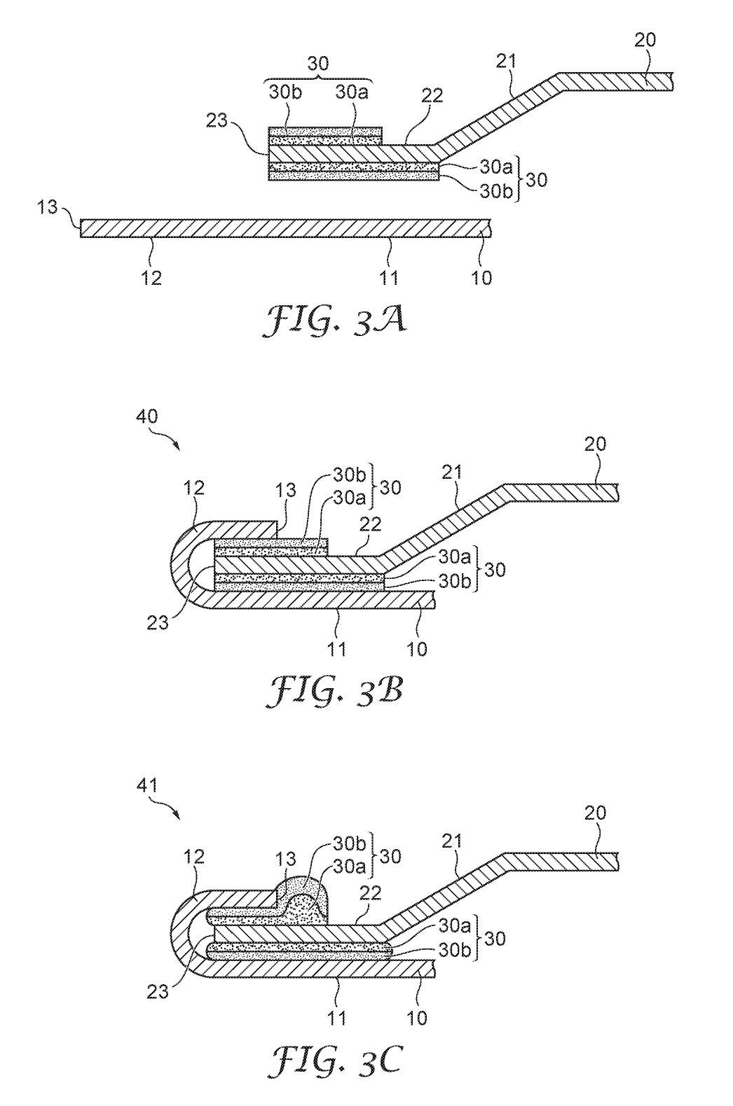

FIGS. 3A to 3C are schematic cross-sectional views illustrating a method for manufacturing a metal member assembly (a method for bonding metal members together) according to an embodiment of the present invention. In this manufacturing method, first, as illustrated in FIG. 3A, an outer steel plate (first metal member) 10 having a main body portion 11 and a bend portion 12; and an inner steel plate (second metal member) 20 having a main body portion 21 and a sandwiched portion 22, and also having a structural adhesive film 30 adhered to both surfaces of the sandwiched portion 22 are prepared (preparation step).

The structural adhesive film 30 includes a first curable resin layer 30a and a second curable resin layer 30b, and the first curable resin layer 30a is adhered to the sandwiched portion 22 of the inner steel plate. In another aspect, instead of the first curable resin layer 30a being adhered to the sandwiched portion 22 of the inner steel plate, the second curable resin layer 30b may be adhered to a predetermined position of the outer steel plate 10. The structural adhesive films 30 adhered to both surfaces of the sandwiched portion 22 of the inner steel plate 20 may be constituted by an integrated structural adhesive film. In this case, the structural adhesive film is disposed having a folded shape so as to cover an edge portion 23 side of the sandwiched portion 22 of the inner steel plate 20 (not illustrated).

Following the preparation step, a bending step is performed. In the bending step, as illustrated in FIG. 3B, the bend portion 12 of a first edge portion 13 side of the outer steel plate 10 is folded back such that the first edge portion 13 side of the outer steel plate 10 sandwiches the sandwiched portion 22 of the inner steel plate 20. At this time, the outer steel plate 10 is folded such that the first edge portion 13 of the outer steel plate 10 is positioned on the second curable resin layer 30b of the structural adhesive film 30. As a result, a metal adhered body 40 having a hem flange structure in which the first edge portion 13 of the outer steel plate 10 and a first surface side of the sandwiched portion 22 of the inner steel plate 20 are adhered to each other, and the main body portion 11 of the outer steel plate 10 and a second surface side of the sandwiched portion 22 of the inner steel plate 20 are adhered to each other.

Next, the metal adhered body 40 obtained in the bending step is heated (heating step). As a result, the first curable resin layer 30a and the second curable resin layer 30b of the structural adhesive film 30 are cured.

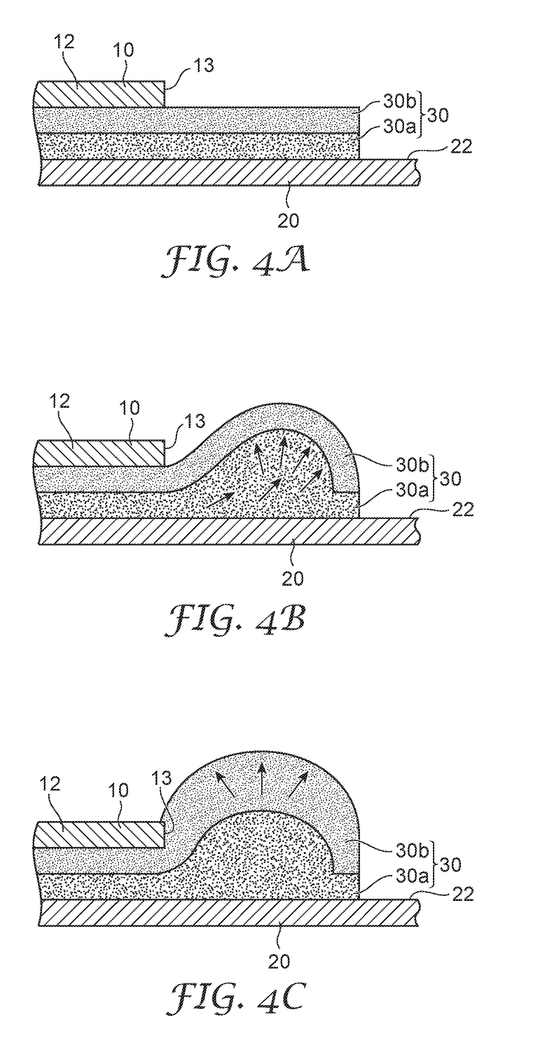

FIGS. 4A to 4C are exploded schematic cross-sectional views of main constituents (near the first edge portion 13 of the outer steel plate 10) of the metal adhered body 40 in the heating step. In the heating step, the metal adhered body 40 obtained in the bending step (FIG. 4A) is heated from room temperature such that the temperature is raised at, for example, a rate of 5 to 15° C. per minute. Accordingly, as illustrated in FIG. 4B, foaming of the first foaming agent contained in the first curable resin layer 30a begins in accordance with the rise in temperature. Next, the curing reaction of the first curable resin layer 30a begins. At this time, the first curable resin layer 30a gradually expands with the start of foaming of the first foaming agent, and upon further raising of the temperature, cures to a point where the expanded shape can be retained.

Here, the curing temperature of the second curable resin layer 30b is higher than the curing temperature of the first curable resin layer 30a, and the curing of the second curable resin layer 30b begins after the start of the curing of the first curable resin layer 30a. Note that the start of curing of the second curable resin layer 30b may be after the completion of the curing of the first curable resin layer 30a or may be during the progression of the curing. Therefore, the second curable resin layer 30b has fluidity when the first curable resin layer 30a has cured to the point where the shape thereof can be retained. As a result, the second curable resin layer 30b can flow along the shape of the expanded and cured first curable resin layer 30a and, as illustrated in FIG. 4C, can cover the first edge portion (edge) 13 of the outer steel plate 10. Moreover, by further raising the temperature, the second curable resin layer 30b can be cured in a state of covering the first edge portion (edge) 13 of the outer steel plate 10.

In cases where the second curable resin layer 30b contains the second foaming agent, the second curable resin layer 30b will flow while expanding due to the foaming of the second foaming agent after the first curable resin layer 30a cures, for example, to the point where the shape thereof can be retained (FIG. 4C). Therefore, the second curable resin layer 30b can more advantageously cover the edge portion (edge) 13 of the outer steel plate 10.

As illustrated in FIG. 3C, a metal member assembly 41 can be obtained by carrying out the heating step described above. As illustrated in FIG. 3C, the metal member assembly 41 includes at least the outer steel plate (first metal member) 10, the inner steel plate (second metal member) 20, and a first bonding member 30.

The first bonding member 30 is disposed on at least a portion (between the first edge portion 13 side of the outer steel plate 10 and the sandwiched portion 22 of the inner steel plate 20) between the outer steel plate 10 and the inner steel plate 20. The first bonding member 30 bonds the first edge portion 13 side of the outer steel plate 10 and a first surface side of the sandwiched portion 22 of the inner steel plate 20 to each other, and also covers the first edge portion (edge) 13 of the outer steel plate 10. The first bonding member 30 is a cured product of the structural adhesive film. In the metal member assembly 41, the first edge portion 13 side of the outer steel plate 10 is folded back so as to sandwich the sandwiched portion 22 of the inner steel plate 20, which forms a hem flange structure.

The metal member assembly 41 may further include a second bonding member for bonding the main body portion 11 of the outer steel plate 10 and the second surface side of the sandwiched portion 22 of the inner steel plate 20 to each other. As illustrated in FIG. 3C, the second bonding member 30 may be a bonding member having the same configuration as, for example, the first bonding member 30.

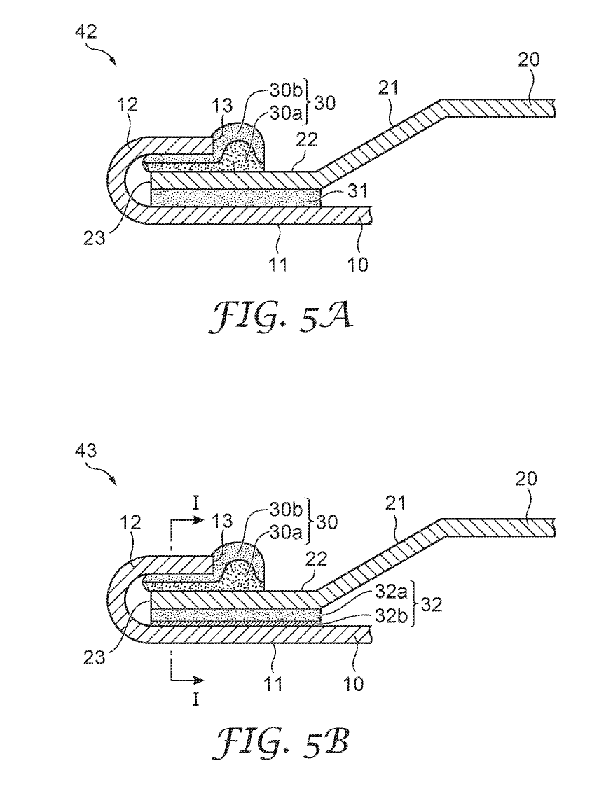

In another aspect, the metal member assembly 41 may include a bonding member as the second bonding member that has a different configuration than the first bonding member 30. FIGS. 5A and 5B are schematic cross-sectional views illustrating a metal member assembly according to another embodiment of the present invention. As such, by dividing the bonding member into a plurality of bonding members, suitable bonding members can be selected at each bonding location.

In the other aspect, as illustrated in FIG. 5A, a metal member assembly 42 includes a bonding member, namely a cured product of an adhesive sheet formed from a single adhesive layer, as a second bonding member 31.

Furthermore, in the other aspect, as illustrated in FIG. 5B, a metal member assembly 43 includes, as the second bonding member 32, a bonding member containing a cured product 32a of an adhesive layer and an air-permeable material 32b embedded in the cured material.

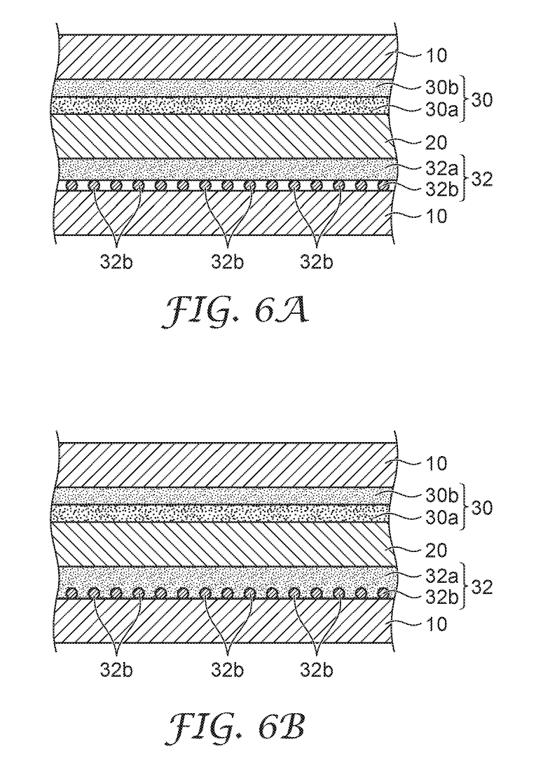

FIGS. 6A and 6B are schematic cross-sectional drawings for explaining a method for manufacturing the metal member assembly 43 depicted in FIG. 5B. FIG. 6B is a schematic cross-sectional view along line I-I of FIG. 5B, in the direction of the arrows. FIG. 6A is a schematic cross-sectional view illustrating a metal adhered body corresponding to the metal member assembly 43 depicted in FIG. 6B (in a state before being subjected to the heating step).

As illustrated in FIG. 6A, an adhesive sheet 32 used in this aspect includes an adhesive layer 32a and an airflow layer including an air-permeable material 32b. The adhesive layer 32a may, for example, contain the thermosetting resin, the thermoplastic resin, the modifier, the curing agent, the curing aid, the spacer, and the like described for the first curable resin layer 30a and the second curable resin layer 30b. Examples of the air-permeable material include fiber materials such as woven fabrics, meshes, knits, and non-woven fabrics. Examples of the fiber materials that can be used include fibrous materials having cotton, glass, polyester, polyimide, polypropylene, carbide, aramid, metal, or a combination thereof as a material. A porous layer can be formed in these air-permeable materials and this layer can function as an airflow layer capable of passing air there-through.

In the hem flange structure, the gap between the edge portion 23 of the inner steel plate 20 and the outer steel plate 10 may be sealed. If volatile matter such as water is present within this sealed gap, when the volatile matter volatilizes and expands in the heating step, the volatile matter may pass through the structural adhesive film or the adhesive sheet for which viscosity has been lowered due to the heating. In such a case, air bubbles may be produced in the end portion of the structural adhesive film or the adhesive sheet and the appearance of the formed bonding member may be negatively affected. As a countermeasure, in this aspect, the air-permeable material 32b (the airflow layer) is present between the adhesive layer 32a and the outer steel plate 10 and, therefore, the volatilized and expanded volatile matter within the gap passes through the air-permeable material 32b (the airflow layer). Thus, in this aspect, the production of air bubbles in the end portions of the structural adhesive film 30 and the adhesive layer 32a is suppressed. As a result, the occurrence of appearance defects occurring at the edges, such as bubbling of the adhesive due to the forming of bubbles, can be prevented. After the volatile matter passes, sufficient bonding strength is ensured due to the adhesive layer 32a, which has been fluidized in the heating step, filling the gaps in the air-permeable material 32b (the airflow layer) and curing (a state where the cured product of the adhesive layer 32a is embedded in the air-permeable material 32b), and coming into contact with the outer steel plate 10 (FIG. 6B). Note that in cases where comparatively stiff woven fabric, mesh, knit, or the like is used as the air-permeable material, the sheet shape before curing can be maintained and effects of making handling easier can be exerted.

Embodiments of the present invention were described above, but the present invention is not limited to the abovementioned embodiments.

### EXAMPLES

The present invention is described more specifically below using working examples, but the present invention is not limited to the working examples. First, evaluation methods used in the Working Examples and the Comparative Examples for each characteristic are explained below.

### Curing Temperature

The curing temperature (curing starting temperature) was defined as a temperature corresponding to a changing point where the slope of a DSC curve (vertical axis: heat quantity, horizontal axis: temperature) obtained through DSC measurement changes to positive.

### Expansion Rate

A sample is applied to a steel plate and placed into an oven, and the sample is baked on the steel plate under heating condition 1 or heating condition 2 (hereinafter, this heating condition is referred to as “heating condition 1”). Thickness was measured before and after the baking and the thickness after baking/the thickness before baking was defined as the expansion rate (%).

Note that the heating condition 1 and the heating condition 2 were as follows.

Heating condition 1: The sample was placed into an oven, and the temperature in the oven was raised from near room temperature to from 170 to 190° C. over about 20 minutes at a rate of temperature raising of about 7° C./min. This temperature was held for 10 minutes. Heating condition 2: The sample was placed in an oven preheated to 180° C. and the temperature was held for 30 minutes.

### T-Peel Strength

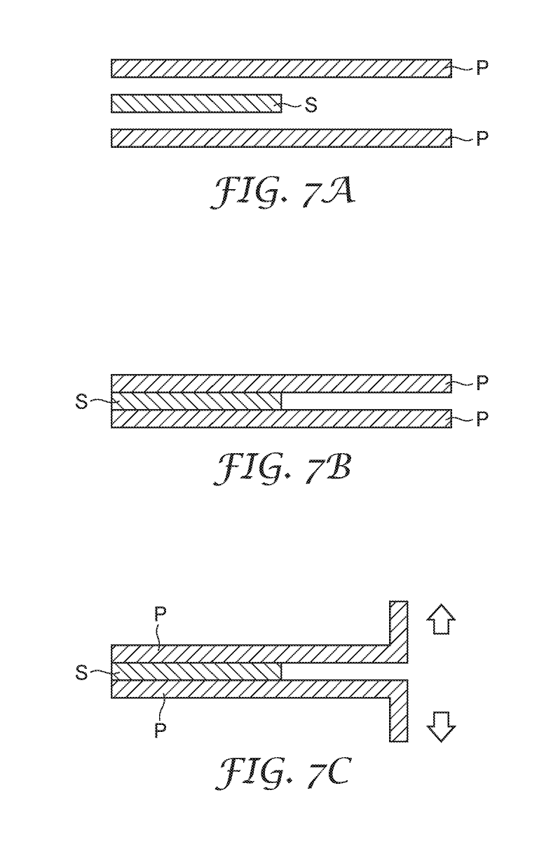

Two steel plates P having a 25 mm×150 mm×0.8 mm thickness, and samples S having a 25 mm×120 mm were prepared (FIG. 7A). The sample S was adhered to one of the steel plates P and, thereafter, the other steel plate P was overlapped on the steel plate P with the sample S and the two steel plates were crimped and fixed using a clip (Note: a 150 μm wire was disposed as a spacer between the steel plates P). The sample S was baked under the heating condition 2 while the steel plates P were crimped by the clip (FIG. 7B). Note that in cases where a portion of the sample S protruded from the steel plates P due to the foaming and cured, the protruding portion was removed. Next, end portions of the steel plates P not sandwiching the adhesive were folded outward 90° and, using the folded portions as gripping tabs, strength when pulling the steel plates P so as to separate in a direction perpendicular to a surface direction of the plates P (FIG. 7C) was measured as the T-peel strength (N/25 mm).

### Shear Strength

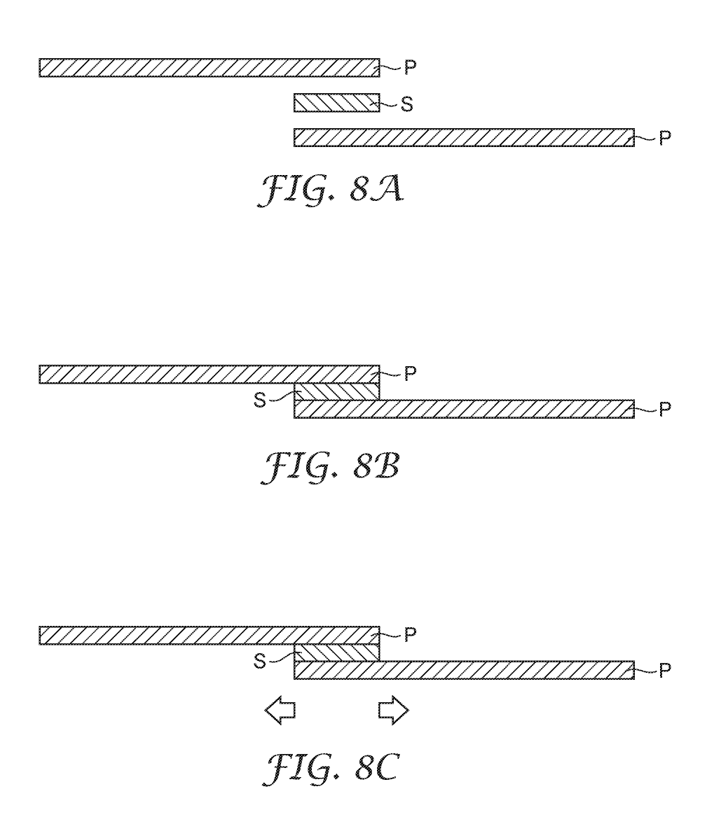

Two steel plates P having a 10 mm×100 mm×1.6 mm thickness, and samples S having a 10 mm×10 mm were prepared (FIG. 8A). The sample S was adhered to the edge portion of one of steel plates P and, thereafter, the other steel plate P was adhered to the steel plate P with the sample S such that the sample S was disposed on the edge portion of the other the steel plates P (Note: as necessary, a 150 μm wire was disposed as a spacer between the steel plates P). The portion where the steel plates P overlapped was crimped and fixed by a clip and the sample S was baked under the heating condition 2 (FIG. 8B). Note that in cases where a portion of the sample S protruded from the steel plates P due to the foaming and cured, the protruding portion was removed. The gripping tabs of each of the steel plates P were gripped and strength when pulling so as to separate the steel plates Pin a surface direction of the steel plates P was measured as the shear strength (MPa; FIG. 8C).

### Evaluation of Edge Coverage

As illustrated in FIGS. 3A to 3C, using the structural adhesive film, the outer steel plate, and the inner steel plate, the structural adhesive film was folded back and adhered so as to cover the edge portion on the inner steel plate side or, alternatively, the structural adhesive film was adhered to each of both surfaces of the sandwiched portion of the inner steel plate. Thereafter, the flanged outer steel plate was pressed (bent at an angle so as to be hemming pressed) so that the inner steel plate was sandwiched by the flanges of the outer steel plate. The resulting product was placed into an oven and the structural adhesive film was baked under the heating condition 1. A cross-section of the sample after the baking was taken and polished, and the cross-section was inspected.

Additionally, a length of the edge of the outer steel plate that the cured product of the structural adhesive film covered (coverage length) was measured. In the sample cross-section, the covered length was defined as the length between the edge portion of the outer steel plate and the end of the cured product of the structural adhesive film that has ridden up on a first surface of the outer steel plate (the surface of the side opposite the inner steel plate).

### Working Examples 1 and 2, Comparative Example 1

### Working Example 1

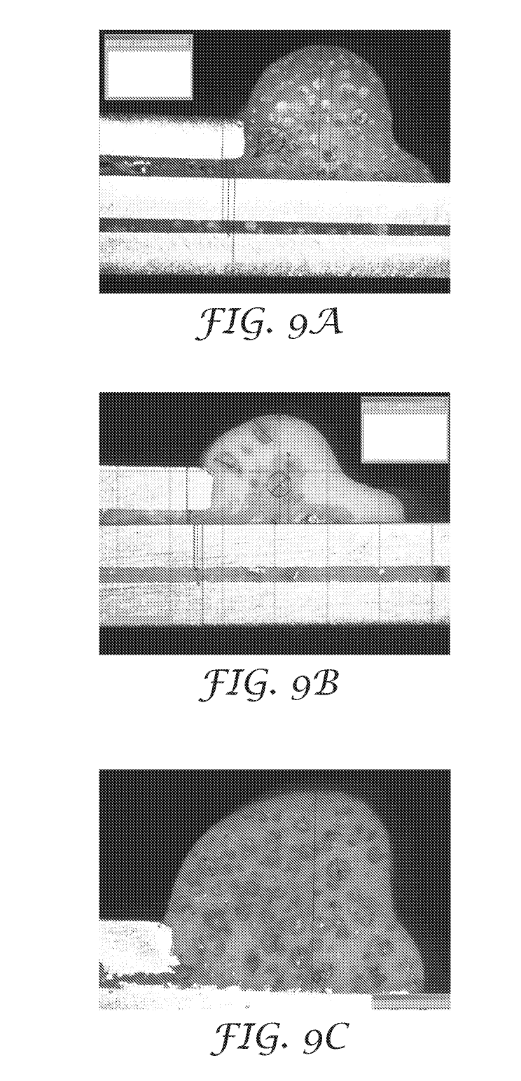

Structural adhesive films constituted by a first curable resin layer and a second curable resin layer having the compositions shown in Table 1 were fabricated. Characteristics (curing temperature, expansion rate, T-peel strength, and shear strength) of each of the first curable resin layer and the second curable resin layer individually, and also characteristics of the structural adhesive film (expansion rate, coverage length, T-peel strength, and shear strength) are shown together in Table 1. Additionally, a cross-section photograph for the evaluation of edge coverage is shown in FIG. 9A.

### Working Example 2

Other than changing the composition of the second curable resin layer as shown in Table 1, a structural adhesive film was fabricated and evaluated in the same manner as in Working Example 1. Results are shown in Table 1 as in Working Example 1, and a cross-section photograph for the evaluation of edge coverage is shown in FIG. 9B.

### Comparative Example 1

Other than forming the structural adhesive film from a single curable resin layer having the composition shown in Table 1, a structural adhesive film was fabricated and evaluated in the same manner as in Working Example 1. Results are shown in Table 1 as in Working Example 1, and a cross-section photograph for the evaluation of edge coverage is shown in FIG. 9C. In Comparative Example 1, while coverage was excellent as in Working Examples 1 and 2 due to having a high expansion rate, adhesion performance, namely T peel-strength and shear strength, was inferior.

TABLE 1

| | | | Working Example 1 | | Working Example 2 | | |
|---|---|---|---|---|---|---|---|
| | | | | Second | | Second | |
| | | | First curable | curable | First curable | curable | Comparative |
| | | | resin layer | resin layer | resin layer | resin layer | Example 1 |
| Composition | Base resin component | | 92.5 | 94.8 | 92.5 | 93.3 | 92.2 |
| (mass %) | Curing agent | CG1200 | 3.2 | 3.2 | 3.2 | 3.2 | 3.2 |
| | Curing aid | Omicure 52 | 1.4 | 0.5 | 1.4 | 0.5 | 0.5 |
| | Spacer | 910L | 1.0 | 1.0 | 1.0 | 1.0 | 1.0 |
| | Foaming agent | FN-100SSD | 2.0 | 0.5 | 2.0 | 2.0 | 0.5 |
| | | F-48D | — | — | — | — | 1.5 |
| Characteristics | Curing temperature (° C.) | | approx. 130 | approx. 150 | approx. 130 | approx. 150 | — |
| of each layer | Expansion rate | Heating | 143 | 130 | 143 | 156 | — |
| | (%) | condition 2 | | | | | |

| | | | | | |
|---|---|---|---|---|---|
| T-peel strength (N/25 mm) | 47.8 | 230.3 | 47.8 | 113.3 | — |
| Shear strength (MPa) | 14.9 | 23.1 | 14.9 | 14.9 | — |

| | | | | | |
|---|---|---|---|---|---|
| Characteristics | Expansion rate | Heating | 130 | 147 | 206 |
| of structural | (%) | condition 1 | | | |
| adhesive film | | Heating | 143 | 156 | 229 |
| | | condition 2 | | | |

| | | | |
|---|---|---|---|
| Coverage length (mm) | 0.2 or longer | 0.2 or longer | 0.2 or longer |
| T-peel strength (N/25 mm) | 218 | 72.5 | 35 |
| Shear strength (MPa) | 20.2 | 10.6 | 10.0 |

Note that the base resin component in Table 1 is a component obtained by mixing 58 mass % of a bisphenol A liquid epoxy as the thermosetting resin (“EPOTOHTO YD-128”, manufactured by Nippon Steel & Sumikin Chemical Co., Ltd.), 28 mass % of a phenoxy resin as the thermoplastic resin (“YP-50S”, manufactured by Nippon Steel & Sumikin Chemical Co., Ltd.), and 14 mass % of the modifier (“BTA-731”, manufactured by Kureha Corporation) at a temperature of 120° C.
Additionally, the abbreviations in Table 1 mean the following materials.
CG1200: Curing agent (“Amicure CG1200”, manufactured by Air Products)
Omicure 52: Curing aid (“Omicure 52”, manufactured by BTR Japan)
910L: Spacer (“910L”, manufactured by Unitika Ltd.)
FN-100SSD: Foaming agent (“Matsumoto Microsphere FM-100SSD”, manufactured by Matsumoto Yushi Seiyaku Co., Ltd.; Foaming starting temperature: approx. 120° C.)
F-48D: Foaming agent (“Matsumoto Microsphere F-48D”, manufactured by Matsumoto Yushi Seiyaku Co., Ltd.; Foaming starting temperature: approx. 90° C.)

### Working Examples 3 to 5 and Comparative Example 2

### Working Example 3

Adhesive compositions for each of the first curable resin layer and the second curable resin layer were prepared according to the compositions shown in Table 2 by sequentially mixing each of the pelletized or powerized materials, having the monomer components (light-reactive monomers) and the epoxy resin as the base.

Each of the adhesive compositions was molded into a sheet shape, such that a thickness thereof is 0.2 mm, between a pair of PET films that have been subjected to light peeling treatment. The molded sheets were subjected to irradiation of ultraviolet light at 1 mW from a light source using an ultraviolet fluorescent lamp (VC7692 T12 bulb, manufactured by Sylvania Corp.) for three minutes, and then were subjected to irradiation at 5 mW for three minutes. The light-reactive monomers cured as a result of the ultraviolet light irradiation, and solidified adhesive sheets between PET films were obtained. The characteristics thereof are shown in Table 2.

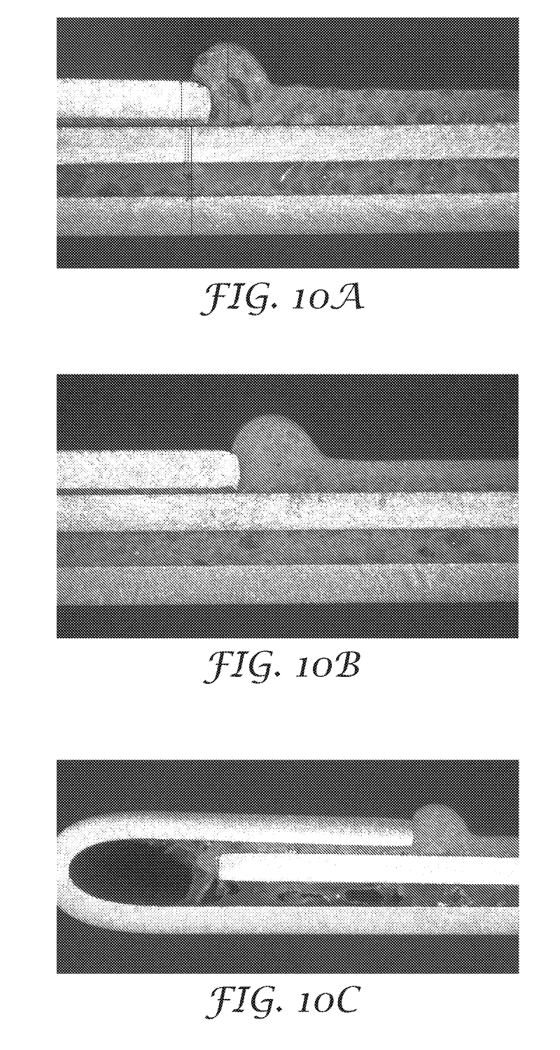

Next, the adhesive sheet for the first curable resin layer and the adhesive sheet for the second curable resin layer were adhered together. Thus, a structural adhesive film with a total thickness of 0.4 mm was obtained. The expansion rate, coverage length, the T peel-strength, and the shear strength of the obtained structural adhesive film are shown in Table 2. Additionally, a cross-section photograph for the evaluation of edge coverage is shown in FIG. 10A.

### Working Example 4

Other than changing the composition of the first curable resin layer and the second curable resin layer to the compositions shown in Table 2, a structural adhesive film was fabricated and evaluated in the same manner as in Working Example 3. Characteristics of the obtained structural adhesive film are shown in Table 2 as with Working Example 3, and a cross-section photograph for the evaluation of edge coverage is shown in FIG. 10B.

### Working Example 5

The structural adhesive film fabricated in Working Example 4 was used as the first bonding member. On the other hand, an adhesive layer was obtained in the same manner as in Working Example 3 at the composition shown in Table 2 as “Adhesive sheet”. The adhesive sheet was formed by adhering this adhesive layer to an air-permeable material, namely a polyester mesh (Product No. EF476, manufactured by Kurashiki Textile Manufacturing Co., Ltd.); and this adhesive sheet was used as the second bonding member. The characteristics of the adhesive sheet are shown in Table 2.

Next, as illustrated in FIGS. 5A and 5B, the first bonding member, namely the structural adhesive film, is adhered to a first surface of the sandwiched portion of the inner steel plate (top surface side of the sandwiched portion 22 of the inner steel plate 20 in FIGS. 5A and 5B); and the second bonding member, namely the adhesive sheet, is adhered to a second surface of the sandwiched portion of the inner steel plate (bottom surface side of the sandwiched portion 22 of the inner steel plate 20 in FIGS. 5A and 5B).

Thereafter, as in Working Example 1, the flanges of the outer steel plate are pressed so as to sandwich the inner steel plate, and baking is performed. Thus, a metal member assembly is fabricated. A cross-section photograph after the baking is shown in FIG. 10C. The edge of the outer steel plate is covered about 0.15 mm. Differences in the compositions of the adhesive sheets are discernible by the differences in the size and color of the foaming traces in the adhesive cross-section.

The mesh was ultimately embedded in the adhesive after being subjected to the baking step, and was integrated into the adhesive layer. Note that the generation of foaming traces in the edge covering portion was suppressed and the appearance thereof was excellent.

### Comparative Example 2

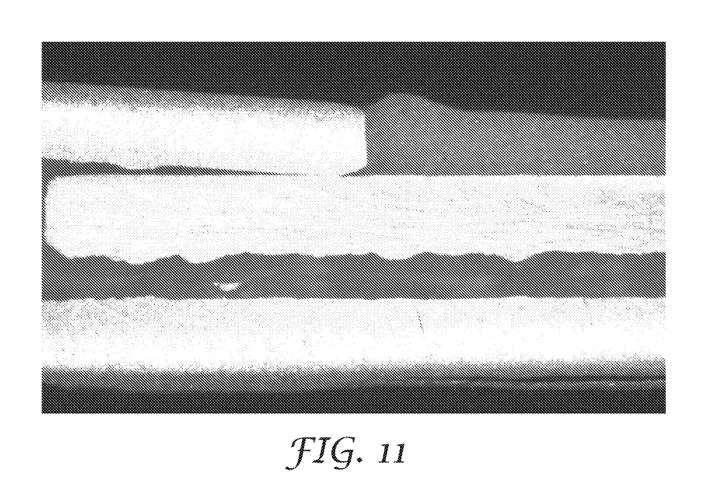

A single layer adhesive sheet formed only from the adhesive layer fabricated in Working Example 5 (the adhesive sheet lacking the air-permeable layer (mesh)) was prepared. This adhesive sheet was used as the first bonding member in Comparative Example 2. The adhesive sheet fabricated in Working Example 5 (the adhesive sheet having the air-permeable layer (mesh)) was used as the second bonding member. As in Working Example 5, evaluation of the edge coverage was performed and the cross-section photograph shown in FIG. 11 was obtained. It is clear that, while the single layer adhesive sheet of Comparative Example 2 displayed high adhesive strength, coverage of the edge of the outer steel plate was not achieved.

TABLE 2

| | | | | | Working | | Working |
|---|---|---|---|---|---|---|---|
| | | | | | Examples 4, 5 | | Example 5 |
| | | | | | (Structural | | Comparative |
| | | | Working Example 3 | | adhesive film) | | Example 2 |
| | | | First curable | Second curable | First curable | Second curable | (Adhesive |
| | | | resin layer | resin layer | resin layer | resin layer | sheet) |
| Composition | Monomer | DMAA | 20 | 20 | 10 | 10 | 15 |
| (parts by mass) | components | FA-511AS | 20 | 20 | 10 | 10 | 20 |
| | | BA | 2 | 2 | 2 | 2 | — |
| | | 2EHA | — | — | — | — | 4 |
| | | GMA | 8 | 8 | 6 | 6 | 6 |
| | | HDDMA | — | — | — | 0.07 | — |
| | Photoinitiator | Irg651 | 0.6 | 0.6 | 0.1 | 0.1 | 0.6 |
| | Phenoxy resin | YP-50S | 16 | 16 | 8 | 8 | 15 |
| | Epoxy resin | YD-128 | 20 | 20 | 80 | 80 | — |
| | | YDF-170 | 54.4 | 54.4 | — | — | 88 |
| | Impact modifier | BTA731 | 25.6 | 25.6 | 20 | 20 | 32 |
| | Thermosetting agent | DICY | 5.6 | 5.6 | 5.6 | 5.6 | 6.9 |
| | Curing aid | 2MZA-PW | 0.5 | — | 0.5 | — | — |
| | | 2PHZ-PW | — | 1 | — | — | 1 |
| | | Omicure52 | — | — | — | 0.5 | — |
| | Foaming agent | FN-100MD | — | 1 | 2 | — | — |
| | | FN-100SD | — | 2 | — | 2 | — |
| | | FN-80GSD | 3 | — | — | — | 1 |
| | Filler | R972 | — | — | — | — | 2 |
| Characteristics of | Curing temperature (° C.) | | approx. 130 | approx. 150 | approx. 130 | approx. 150 | — |
| each layer | Expansion rate (%) | Heating | — | — | — | — | 120 |
| | | condition 1 | | | | | |
| | | Heating | 139 | 131 | 142 | 128 | — |
| | | condition 2 | | | | | |

| | | | | | |
|---|---|---|---|---|---|
| T-peel strength (N/25 mm) | 85 | 65 | 95 | 120 | 218 |
| Shear strength (MPa) | 24.4 | 21.4 | 17.8 | 25.3 | 19.1 |

| | | | | | |
|---|---|---|---|---|---|
| Characteristics of | Expansion rate (%) | Heating | 131 | 168 | — |
| structural | | condition 1 | | | |

| | | | | |
|---|---|---|---|---|
| adhesive film | Coverage length (mm) | 0.3 or longer | 0.1 or longer | — |
| | T-peel strength (N/25 mm) | 60 | 105 | — |
| | Shear strength (MPa) | 19.2 | 24.5 | — |

Note that the abbreviations in Table 2 mean the following materials.
DMAA: Dimethyl acrylamide
FA-511AS: Dicyclopentenyl acrylate
BA: n-Butyl acrylate
2EHA: 2-Ethylhexyl acrylate
GMA: Glycidyl methacrylate
Irg651: Photocurable radical polymerization initiator (“Irugacure 651”, manufactured by BASF)
YP-50S: Phenoxy resin (“YP-50S”, manufactured by Nippon Steel & Sumikin Chemical Co., Ltd.)
YD-128: Bisphenol A type epoxy resin (“YD-128”, manufactured by Nippon Steel & Sumikin Chemical Co., Ltd.)
YDF-170: Bisphenol F type epoxy resin (“YDF-170”, manufactured by Nippon Steel & Sumikin Chemical Co., Ltd.)
BTA731: Core-shell-type impact modifier (“BTA731”, manufactured by Rohm & Hass Co.)
DICY: Thermosetting epoxy resin curing agent dicyandiamide (“EH3636AS”, manufactured by ADEKA Corporation)
2MZA-PW: Curing aid (“2MZA-PW”, manufactured by Shikoku Chemicals Corporation)
2PHZ-PW: Curing aid (“2PHZ-PW”, manufactured by Shikoku Chemicals Corporation)
R972: Hydrophobic surface-treated silica (“R-972”, manufactured by Nippon Aerosil Co., Ltd.)
FN-100MD: Foaming agent (“FM-100MD”, manufactured by Matsumoto Yushi Seiyaku Co., Ltd.; Foaming starting temperature: approx. 125° C.)
FN-100SD: Foaming agent (“FN-100SD”, manufactured by Matsumoto Yushi Seiyaku Co., Ltd.; Foaming starting temperature: approx. 125° C.)
FN-80GSD: Foaming agent (“FN-80GSD”, manufactured by Matsumoto Yushi Seiyaku Co., Ltd.; Foaming starting temperature: approx. 100° C.)

As shown above, with the structural adhesive film according to the present invention, it is clear that both adhesion and edge coverage can be achieved.

1. A structural adhesive film comprising:
a first curable resin layer containing a first thermosetting resin and a first foaming agent; and
a second curable resin layer containing a second thermosetting resin;
a curing temperature of the first curable resin layer being lower than a curing temperature of the second curable resin layer; and
a foaming starting temperature of the first foaming agent being lower than the curing temperature of the first curable resin layer.

2. The structural adhesive film according to claim 1, wherein a difference between the curing temperature of the first curable resin layer and the curing temperature of the second curable resin layer is 5° C. or greater.

3. The structural adhesive film according to claim 1, wherein the second curable resin layer further comprises a second foaming agent.

4. The structural adhesive film according to claim 3, wherein a foaming starting temperature of the second foaming agent is higher than the curing temperature of the first curable resin layer.

5. The structural adhesive film according to claim 1, to wherein the first thermosetting resin and the second thermosetting resin are epoxy resins.

6. The structural adhesive film according to claim 1, wherein the first curable resin layer and the second curable resin layer further comprises acrylic resins.

7. A method for manufacturing a metal member assembly comprising:
a first step of forming a metal adhered body by disposing the structural adhesive film described in claim 1 between a first metal member and a second metal member; and
a second step of obtaining a metal member assembly by heating the metal adhered body so as to cure the first curable resin layer and the second curable resin layer, and bonding the first metal member and the second metal member to each other via a first bonding member containing a cured product of the structural adhesive film; wherein in the second step, foaming of the first foaming agent, curing of the first curable resin layer, and curing of the second curable resin layer are initiated in this order.

8. The method for manufacturing a metal member assembly according to claim 7, wherein:
in the first step,
a side of a first edge portion of the first metal member is folded back and a hem flange structure is formed so as to sandwich the second metal member, and
the structural adhesive film is disposed so as to adhere at least the first edge portion of the first metal member and a first surface side of the second metal member to each other.

9. The method for manufacturing a metal member assembly according to claim 8, wherein, in the first step, an adhesive sheet is further disposed at least between the first metal member and a second surface side of the second metal member.

10. The method for manufacturing a metal member assembly according to claim 9, wherein:
an adhesive sheet comprising an adhesive layer and an airflow layer containing an air-permeable material is used as the adhesive sheet, and
in the second step,
the metal adhered body is heated so as to cure the adhesive layer and the air-permeable material is embedded in the adhesive layer, and
the first metal member and the second surface side of the second metal member are bonded to each other via a second bonding member containing a cured product of the adhesive layer and the air-permeable material embedded in the cured product.

11. The method for manufacturing a metal member assembly according to claim 10, wherein the air-permeable material is a woven fabric, a mesh, a knit, or a nonwoven fabric.

12. A metal member assembly comprising:
a first metal member;
a second metal member; and
a first bonding material containing a cured product of the structural adhesive film according to claim 1;
at least a portion of the first bonding material being disposed between the first metal member and the second metal member, and bonding the first metal member and the second metal member to each other.

13. The metal member assembly according to claim 12, wherein:
a side of a first edge portion of the first metal member is folded back and a hem flange structure is formed so as to sandwich the second metal member, and
the first bonding member bonds the first end portion of the first metal member and a first surface side of the second metal member to each other.

14. The metal member assembly according to claim 13, further comprising a second bonding member that bonds the first metal member and a second surface side of the second metal member to each other.

15. The metal member assembly according to claim 14, wherein the second bonding member comprises a cured product of an adhesive layer and an air-permeable material embedded in the cured product.

16. The metal member assembly according to claim 15, wherein the air-permeable material is a woven fabric, a mesh, a knit, or a nonwoven fabric.

17. The structural adhesive film according to claim 2, wherein the second curable resin layer further comprises a second foaming agent.

18. The structural adhesive film according to claim 4, wherein the first thermosetting resin and the second thermosetting resin are epoxy resins.

19. The structural adhesive film according to claim 5, wherein the first curable resin layer and the second curable resin layer further comprises acrylic resins.

20. The structural adhesive film according to claim 18, wherein the first curable resin layer and the second curable resin layer further comprises acrylic resins.
